(19) United States
(12) Patent Application Publication
(10) Pub. No.: US 2025/0214098 A1
(43) Pub. Date: Jul. 3, 2025

(54) AUTONOMOUS GROUND DEPOSITION MACHINE WITH MULTIPLE ACCESSORY MEANS

(71) Applicant: Micropply Limited, Altrincham, Cheshire (GB)

(72) Inventors: Anthony David George Rhoades, Hale, Altrincham (GB); Samuel Paul Cornish-Evans, Knutsford, Cheshire (GB); Lewis Cassidy, Stretford, Manchester (GB)

(21) Appl. No.: 18/853,183

(22) PCT Filed: Apr. 6, 2023
(86) PCT No.: PCT/GB2023/050923

§ 371 Date: Oct. 1, 2024

(30) Foreign Application Priority Data
Apr. 6, 2022 (GB) 2205018.1

(51) Int. Cl. B05B 13/00; A63C 19/06; B05B 7/32; B05B 12/04

(52) U.S. Cl. CPC B05B 13/005; A63C 19/065; B05B 7/32; B05B 12/04; A63C 2019/067

(57) ABSTRACT

A detachable deposition accessory for coupling to an autonomous deposition apparatus, and an autonomous deposition apparatus with reciprocal coupling, the detachable deposition accessory having: a locomotion arrangement; a deposition arrangement; a control unit, the control unit operable to receive at least one deposition instruction from the autonomous deposition apparatus; and a coupling capable of attaching the detachable deposition accessory to an autonomous deposition apparatus. Thus advantageously, there is provided the capability to quickly and easily change the abilities of the autonomous deposition machine for multiple different deposition application situations.

The present invention relates to an Autonomous Deposition Robot (ADR) and a detachable, deposition accessory for an ADR of a type equipped to deposit materials such as an ink and paint, but may equally deposit sand, seed, fertiliser, or other ground treatments onto a ground surface or for Injection under pressure into a ground surface.

### BACKGROUND

Ground marking is typically carried out manually. It requires significant pre-planning, the manufacture of pre-ordered plastic stencils, and large teams of workers to decipher instructions, prepare, lay out, and complete a site for marking. Where marking is required such as for logos, safety or hazard signs, the complex make-up of these images mean that difficulties persist to print any image, any size, any colour, directly onto any ground surface without significant cost of time, expense and compromise in image attributes, such as resolution.

One approach to automating ground marking is found in US 2005/0055142 A1 in which a turf image marker comprises a ground maintenance vehicle adapted to both mow and store grass as well as carry a marking device that includes a delivery system for applying a marking material to the ground, Dispensing devices for putting down marking materials are provided in the form of boxes requiring mechanisms that require to be driven such as a motor, electric, air or other fluid motor,

One approach to scalable autonomous ground marking is found in the Applicant's co pending patent “Ground Printing Machine”, Micropply Limited, PCT/GB2021/052671, which discloses an ADR machine capable of ground printing and which uses the tiling of segments to cover a large image print area.

Another approach is found in Pixelrunner's application US 2019381529, which discloses using a single fixed sprayer arm with numerous nozzle assemblies arranged next to one another.

Autonomous Vehicles may be completely autonomous (i.e. free from human operation and/or supervision) or may require at least partial human operation and/or supervision depending on the application.

### SUMMARY OF INVENTION

According to a first aspect of the present invention, there is provided a detachable deposition accessory for coupling to an autonomous deposition apparatus, the detachable deposition accessory comprising: a locomotion arrangement; a deposition arrangement; a control unit, the control unit operable to receive at least one deposition instruction from the autonomous deposition apparatus; and a coupling capable of attaching the detachable deposition accessory to an autonomous deposition apparatus.

Preferably wherein the coupling further comprises a data connection, wherein the date connection may be operable to send data between the detachable deposition accessory and the autonomous deposition apparatus. Further preferably wherein the control unit is operable to send data from the detachable deposition accessory to the autonomous deposition apparatus.

Also, wherein the coupling may further preferably comprise a power connection, wherein the power connection may be operable to send electrical power between the detachable deposition accessory and the autonomous deposition apparatus. Also, wherein the coupling may further comprise at least one conduit, wherein the at least one conduit may be capable of transferring deposition material between the detachable deposition accessory and the autonomous deposition apparatus.

Further preferably wherein the coupling further comprises magnetic attachment means, wherein the magnetic attachment means may be a hot shoe arrangement.

Preferably wherein the detachable deposition accessory further comprises a chassis with a nozzle array on a traverse guide. Wherein the traverse guide may permit movement of the nozzle array beyond the width of the ground wheel arrangement of the autonomous deposition apparatus.

Thus advantageously, there is provided the means to quickly and easily change the abilities of the autonomous deposition machine for multiple different deposition application situations.

In a second aspect of the present invention, there is provided an autonomous deposition apparatus, the autonomous deposition apparatus comprising: at least one receptacle to hold a deposition material; a locomotion arrangement; a control unit, the control unit operable to receive at least one deposition instruction; and a coupling capable of attaching to a detachable deposition accessory according to the first aspect. Preferably wherein autonomous deposition apparatus may further comprise a deposition arrangement.

In a third aspect of the present invention, there is provided a method of depositing a material using the apparatus of the second aspect, the method comprising: an operator coupling a detachable deposition accessory of any of the preceding claims to an autonomous deposition machine; receiving at least one deposition instruction from a user; the autonomous deposition apparatus controlling the detachable deposition accessory to deposit material according to the deposition instructions.

Preferably wherein after it is coupled to the autonomous deposition machine, the detachable deposition accessory is operable to send data to the autonomous deposition machine. Further preferably, wherein after it is coupled to the autonomous deposition machine, the detachable deposition accessory overrides any internal deposition arrangement of the autonomous deposition machine.

Further preferably wherein the deposition instructions are a command to print an image in a certain size and the control unit calculates the required sections of the print and/or wherein the user sends deposition instructions to the autonomous deposition apparatus via a cloud server or device, or an edge server or device.

Preferably wherein the material for deposition is a herbicide, pesticide, insecticide, plant growth aid, water or marking material, optionally wherein the marking material is a paint, ink, coloured material, powder.

Preferably, the autonomous deposition machine is connected to a cloud system. Connection to a cloud system allows the user to achieve functionality anywhere, for example over the air fault diagnostics, real-time print management, vast secure storage and the means to operate robots anywhere in the operator's network. Use of a cloud system allows the collection of data which can aid in machine learning functionality, improve robot diagnostics, data aggregation and secure communication links between the edge, the cloud and all data processing devices as required. Use of a cloud-based system is built around the user to achieve functionality anywhere, over the air fault diagnostics, real-time print management, vast secure storage and the means to operate robotic printers anywhere in the operator's network.

Thus, there is provided an improved high-resolution grand-scale accuracy of ground printing and deposition systems. Furthermore, delivering world leading navigational accuracy for a ground marking system ensuring market-leading flexibility, scalability, ease-of-use, and robustness for the ground marking systems. With these elements in place, ADRs such as the one disclosed in this application can fully satisfy even the most extreme scale market demands such as ‘full pitch’ print activations used in the NFL (National Football League).

### FIGURES

Embodiments of the invention will now be described by way of example only and with reference to the accompanying drawings, in which:

FIG. 1 is a schematic diagram of an autonomous ground deposition robot coupled to a detachable extra wide print rack, according to one embodiment of the present invention;

FIG. 2 is a plan view of the ground deposition robot, coupled to a detachable extra wide print rack, of FIG. 1;

FIG. 3 is a side elevation of the ground deposition robot, coupled to a detachable extra wide print rack, of FIGS. 1 & 2; and

FIGS. 4a and 4b are a side view and a plan view of a ground deposition robot, coupled to a detachable print rack, according to a second embodiment of the present invention; and

FIG. 5 is a schematic diagram of primary packaging comprising a flexible ink bag with a hose which can be coupled to the nozzle arrays of the autonomous ground deposition robots of any of FIGS. 1 to 4b.

The present techniques will be described more fully hereinafter with reference to the accompanying drawings. Like numbers refer to like elements throughout. Parts of the autonomous ground printer are not necessarily to scale and may just be representative of components of the ground print machines, or other described entities.

### DETAILED DESCRIPTION

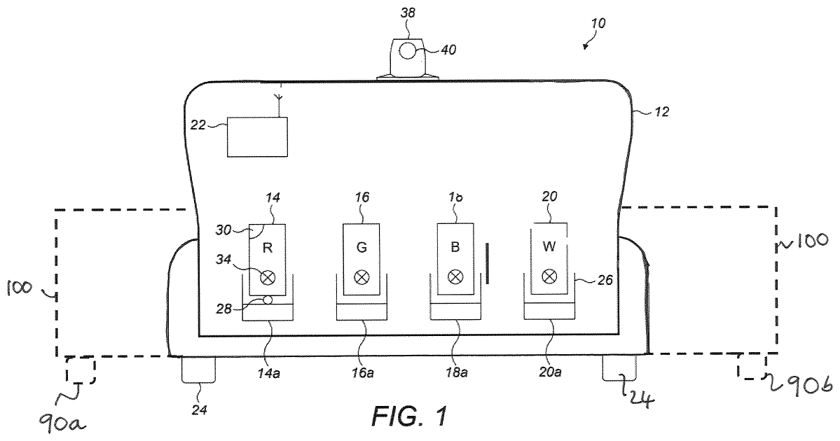

Referring to FIG. 1 a schematic diagram of an autonomous ground deposition robot, which comprises an outer case 12 cut away to reveal an array of primary packaging 14, 16, 18 and 20. The primary packaging 14, 16, 18 and 20 shown here comprising ink held within a bag (not shown in FIG. 1), with primary packaging 14 comprising a red ink R, a green ink G, a blue ink B and a white ink W. Each primary packaging 14, 16, 18 and 20 is supported on a weight measuring plate 14a, 16a, 18a and 20a connected to an on-board control system 22.

The on-board control system 22 further comprises a transceiver 22a for communication with remote resources, such as the cloud (not shown in FIG. 1), for example over a wireless communication link 86 and is further described with reference to the Applicants co-pending patent applications.

Each weight measuring plate 14a, 16a, 18a and 20a is an integral part of a frame 26 capable of holding the primary packaging 14, 16, 18, 20 firmly in place and comprises a load sensor 28 for registering the presence of the primary packaging 14, 16, 18, 20 when firmly in place in the frame 26.

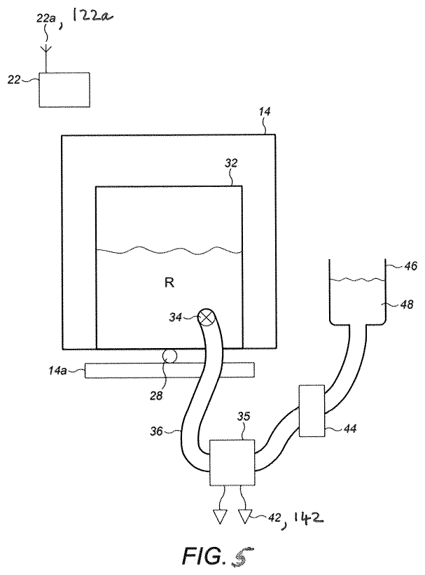

As best seen in FIG. 5, a flexible ink bag 32 comprises an airtight valve outlet 34 sealed to the flexible ink bag 32 with the appropriate connection part for secure connection to a hose 36. The hose 36 may also be a tube, piping, or any suitable means to transport the material for deposition.

The autonomous ground deposition robot 10 further comprises wheels 24 for movement, a position sensor 38 and laser 40. Position sensor 38 may comprises a Global Positioning Device for navigation or the autonomous ground deposition robot 10 may use triangulation with known positioning reflectors and the laser 40 for positioning. Other navigational methods are described in the Applicant's co-pending applications.

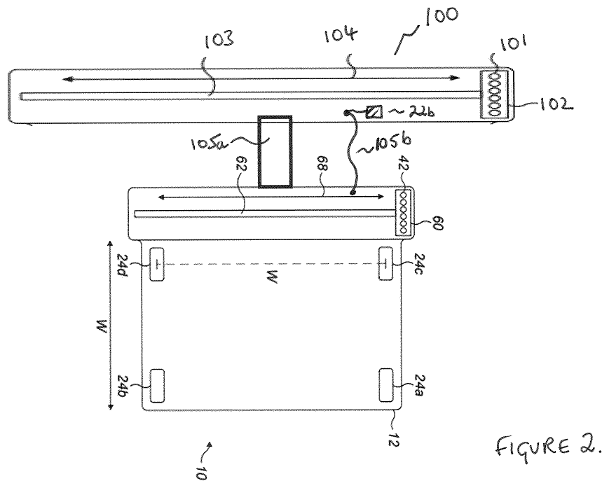

There is also shown in FIG. 1 an extra wide detachable print head accessory 100, wherein the detachable print head accessory 100 is connected to the autonomous ground deposition robot 10 by a magnetic coupling means (not shown in FIG. 1) and is supported by an extra set of wheels 90a, 90b. The extra wide detachable print head accessory 100 is described further with reference to FIG. 2.

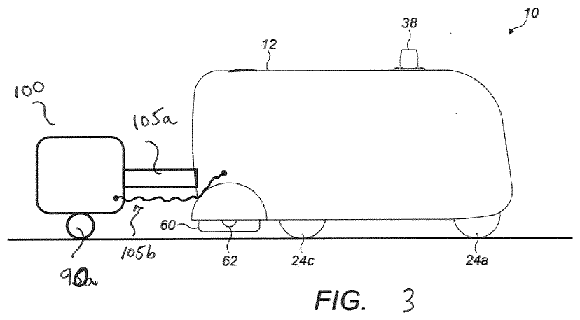

FIG. 2 is a plan view and FIG. 3 is a side elevation of the autonomous ground deposition robot 10, coupled to an extra wide detachable print head accessory of the present invention. In both FIGS. 2 and 3, there is shown the autonomous ground deposition robot 10, comprising a case 12 held securely by a chassis supporting the ground wheel arrangement 24 with an internal print head 60 on a traverse guide 62, the traverse guide 62 permitting movement of the print head 60 beyond the width W of the ground wheel arrangement 24, along the length of the standard operation print width 68. The nozzle array 42 as described above may be attached to the print head 60. The nozzles maybe fixed and the print head 60 moveable. The print head 60, via the print guide 62, may be moveable along the length of a print width 68, which is the area the print head is capable of printing in ‘normal’ operation, that is without the attachment of the extra wide detachable print head accessory 100 of the present invention.

As best shown in FIG. 2, the ground wheel arrangement 24 further comprises wheels 24a, 24b, 24c and 24d to steer the autonomous ground deposition robot 10 along a path to affect the printing, and this may be under the control of a print file that can be loaded into the on-board control system such as may be contained communications module 22, as further described with reference to the Applicants' co pending applications.

There is also shown the extra wide detachable print head accessory 100, which comprises an extra wide traverse guide 103, a second print head arrangement 102 and 6 extra nozzles 101. The extra wide traverse guide 103 permitting movement of the second print head arrangement 102 along the length of an extra wide print width 104.

Wherein the detachable print head accessory 100 is connected, or coupled, to the chassis of the autonomous ground deposition robot 10 by a magnetic ‘hot shoe’ connection 105a. The magnetic ‘hot shoe’ connection 105a being powerful enough and strong enough to keep the detachable print head accessory 100 attached securely enough to minimise any lateral or vibrational movement between the detachable print head accessory 100 and the autonomous ground deposition robot 10. Suitable magnetic ‘hot shoe’ connections 105a are known in the art, for example, they may be used as a mounting point on the top of a camera to attach a flash unit and other compatible accessories. Suh a hot shoe takes the form of an angled metal bracket surrounding a metal contact point, which completes an electrical connection between camera and accessory for standard, brand-independent flash synchronization.

Also connecting the detachable print head accessory 100 to the autonomous ground deposition robot 10 is an umbilical 105b, wherein the umbilical 105b further comprises a serial data cable, a 10-amp power cable and 6 hydraulic lines (not shown). The umbilical 105b is connected to the autonomous ground deposition robot 10 via a male/female socket which is mounted on a mounting plate on the underside of the autonomous ground deposition robot 10 (not shown). Although any suitable connection means can be used for the specific parent/child arrangement needed.

The serial data cable is connected to a sub-controller 22b, which further comprises an application processor (not shown), which comprises software code about the detachable print head accessory 100. The software code comprising key usage variables and information about the detachable print head accessory 100, which when the umbilical 105b is connected, the information is uploaded to the autonomous ground deposition robot 10 such that the autonomous ground deposition robot 10 can operate the detachable print head accessory 100. Thus, the detachable print head accessory 100 has independent processing capability and can carry out tasks that the ‘parent’ autonomous ground deposition robot 10 gives it.

Once the detachable print head accessory 100 is coupled to the autonomous ground deposition robot 10, the software loaded on the application processor of the sub-controller 22b may also carry out such activities as to check the detachable print head accessory 100 is authorised and/or is compatible to be used with the autonomous ground deposition robot 10.

As mentioned, the umbilical 105b also comprises 6 hydraulic lines (not shown), which are connected to a reciprocal connector (not shown) on the underside of the autonomous ground deposition robot 10. When these hydraulic lines are connected and the detachable print head accessory 100 software is uploaded as previously mentioned, then the operation of the internal print head 62 (as described in FIGS. 1 to 3) is overridden and the internal print head 62 is now out of operation.

As such, the autonomous ground deposition robot 10 can control the detachable print head accessory 100 and specifically, paints or deposition materials can be directly pumped to the nozzles 101 of the print head 102 of the detachable print head accessory 100. Via the serial data connection (not shown), the autonomous ground deposition robot 10 may also gather performance diagnostics of the detachable print head accessory 100, such as faults, errors messages and or consumption of materials.

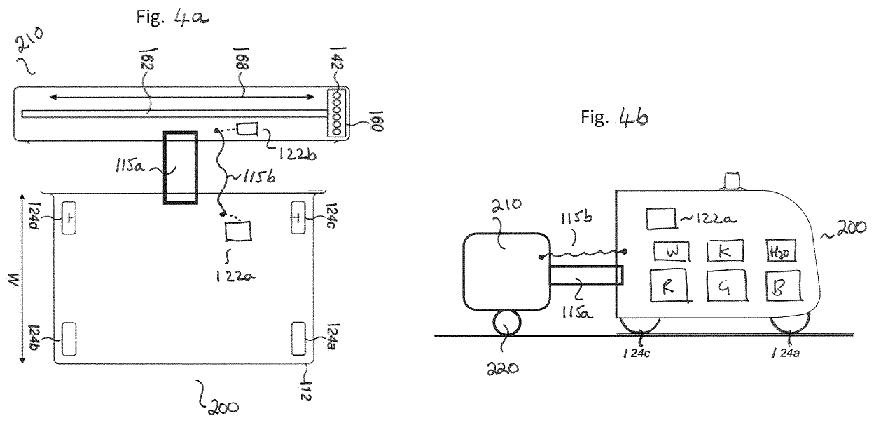

FIG. 4a is a plan view and FIG. 4b is a side elevation of the autonomous ground deposition robot, coupled to a detachable print head accessory, according to a second embodiment of the present invention. In both FIGS. 4a and 4b, there is shown an autonomous ground deposition robot 200, comprising a case 112 held securely by a chassis supporting the ground wheel arrangement 124.

As best shown in FIG. 4a, the ground wheel arrangement 124 further comprises wheels 124a, 124b, 124c and 24d to steer the autonomous ground deposition robot 200 along a path to affect the printing, and this may be under the control of a print file that can be loaded into the on-board control system such as may be contained in communications module 122a, as further described with reference to the Applicants' co pending applications.

There is also shown a detachable print head accessory 210, which comprises a traverse guide 162, a print head arrangement 160 and nozzle array 142. The traverse guide 162 permitting movement of the print head arrangement 142 along the length of a print width 168. Wherein the detachable print head accessory 210 is connected, or coupled, to the chassis of the autonomous ground deposition robot 200 by a magnetic ‘hot shoe’ connection 115a. The magnetic ‘hot shoe’ connection 115a being powerful enough and strong enough to keep the detachable print head accessory 210 attached securely enough to minimise any lateral or vibrational movement between the detachable print head accessory 210 and the autonomous ground deposition robot 200.

Also connecting the detachable print head accessory 210 to the autonomous ground deposition robot 200 is an umbilical 115b, wherein the umbilical 115b further comprises a serial data cable, a 10-amp power cable and 6 hydraulic lines (not shown). The umbilical 115b is connected to the autonomous ground deposition robot 200 via a male/female socket which is mounted on a mounting plate on the underside of the autonomous ground deposition robot 200 (not shown), Although any suitable connection means can be used for the specific parent/child arrangement needed.

The serial data cable is connected to a sub-controller 122b, which further comprises an application processor (not shown), which comprises software code about the detachable print head accessory 210. The software code comprising key usage variables and information about the detachable print head accessory 210, which when the umbilical 115b is connected, the information is uploaded to the autonomous ground deposition robot 200 such that the autonomous ground deposition robot 200 can operate the detachable print head accessory 210. Thus, the detachable print head accessory 100 has independent processing capability and can carry out tasks that the ‘parent’ autonomous ground deposition robot 200 gives it.

Once the detachable print head accessory 210 is coupled to the autonomous ground deposition robot 200, the software loaded on the application processor of the sub-controller 122b may also carry out such activities as to check the detachable print head accessory 210 is authorised and/or is compatible to be used with the autonomous ground deposition robot 200.

As mentioned, the umbilical 115b also comprises 6 hydraulic lines (not shown), which are connected to a reciprocal connector (not shown) on the underside of the autonomous ground deposition robot 200. As such, the autonomous ground deposition robot 200 can control the detachable print head accessory 210 and specifically, paints or deposition materials can be directly pumped to the nozzle array 142 of the print head 62 of the detachable print head accessory 210. Via the serial data connection (not shown), the autonomous ground deposition robot 200 may also gather performance diagnostics of the detachable print head accessory 210, such as faults, errors messages and or consumption of materials.

Although shown as such in FIGS. 1 to 4b, the detachable print head accessory 100 does not necessarily have to be symmetrical around the centre of the autonomous ground deposition robot 10, although for load balancing reasons this may be the most appropriate arrangement for the function being carried out. Using the umbilical 105b, 115b, many different accessories could be connected to the autonomous ground deposition robots 10, 200, though only if the accessory has a matching connector, with matching serial cable, power feed and suitable hydraulic lines to match the connector and which are all suitable for the deposition materials being housed in the autonomous ground deposition robots 10, 200 ready for deposition.

Turning to FIG. 5, the primary packaging 14 comprising the flexible ink bag 32 with the hose 36 is connected to a nozzle array 42 via an actuator pump 35. In the embodiment as described with reference to FIGS. 1 to 3, without the attachment of the detachable print head accessory the nozzle array 42 acts as the means to deposit the material for deposition. Any such suitable nozzle, nozzle array or means to deposit the material, depending on the actual material to be deposited, may be used, when in an ‘uncoupled’ mode of operation.

When used with the embodiment as described with reference to FIGS. 4a and 4b, with the attachment of the detachable print head accessory, the nozzle array 142 (of FIG. 4a) acts as the means to deposit the material for deposition.

Each ink bag of the primary packaging 14, 16, 18 and 20 will have a hose 36 and valve 34 to connect to the nozzle array 42, 142 via the actuator pump 35. The autonomous ground deposition robot 10, 200 may have a single actuator pump 35 for all primary packaging/ink bag/hose (14,16,18,20/32/36), or there may be multiple actuator pumps, i.e. one for each primary packaging/ink bags/hose (14,16,18,20/32/36). Each nozzle of the nozzle array 42, 142 may be designated for each primary packaging/ink bag/hose (14,16,18,20/32/36) present, so that each nozzle is for deposition of only the material held in each primary packing/ink bag (14,16,18,20/32).

The bags 32 may contain different colours of marking materials, or a chemical to deposit on the ground, such as a herbicide, pesticide, insecticide, paint, ink, coloured material, powder, fertilizer, plant growth aid or water, or the like provided that a compatible hose 36 and nozzle arrays 42, 142 are attached. The hose 36 is connected to a manifold 44 connected to a tank 46 containing chemical liquids 48 which serve a variety of purposes. The chemical liquids 48 may be used to flush the hose 36 and nozzles 42, as described in the Applicants' co pending applications.

It will be clear to one skilled in the art that many improvements and modifications can be made to the foregoing exemplary embodiments without departing from the scope of the present technique.

The robots, systems, and methods described herein can be adapted for use with different types of surface of substrate, depending on the purpose and surface for it to be used with. For example, the robots, systems, and methods described herein can be used to deposit material on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The robots, systems, and methods described herein can be adapted for use with different surfaces, such as sports (e.g. football, cricket, racing, rugby, hockey, ice hockey, skiing, shooting) pitches, ski slopes, dry ski slopes, race courses, gymnasiums, indoor sports venues and running tracks.

1. A detachable deposition accessory for coupling to an autonomous deposition apparatus, the detachable deposition accessory comprising:
a locomotion arrangement;
a deposition arrangement;
a control unit, the control unit operable to receive at least one deposition instruction from the autonomous deposition apparatus; and
a coupling capable of attaching the detachable deposition accessory to an autonomous deposition apparatus.

2. A detachable deposition accessory according to claim 1, wherein the coupling further comprises a data connection, wherein the data connection is operable to send data between the detachable deposition accessory and the autonomous deposition apparatus.

3. A detachable deposition accessory according to claim 1, wherein the coupling further comprises a power connection, wherein the power connection is operable to send electrical power between the detachable deposition accessory and the autonomous deposition apparatus.

4. A detachable deposition accessory according to claim 1, wherein the coupling further comprises at least one conduit, wherein the at least one conduit is capable of transferring deposition material between the detachable deposition accessory and the autonomous deposition apparatus.

5. A detachable deposition accessory according to claim 1, wherein the control unit operable to send data from the detachable deposition accessory to the autonomous deposition apparatus.

6. A detachable deposition accessory according to claim 1, wherein the coupling further comprises magnetic attachment means.

7. A detachable deposition accessory according to claim 1, wherein the magnetic attachment means is a hot shoe arrangement.

8. A detachable deposition accessory according to claim 1, wherein the detachable deposition accessory further comprises a chassis with a nozzle array on a traverse guide.

9. A detachable deposition accessory according to claim 8, wherein the traverse guide permits movement of the nozzle array beyond the width of the ground wheel arrangement of the autonomous deposition apparatus.

10. An autonomous deposition apparatus, the autonomous deposition apparatus comprising:
at least one receptacle to hold a deposition material;
a locomotion arrangement;
a control unit, the control unit operable to receive the at least one deposition instruction; and
a coupling capable of attaching to the detachable deposition accessory according to claim 1.

11. An autonomous deposition apparatus according to claim 10, further comprising a deposition arrangement.

12. A method of depositing a material using the apparatus of claim 10, the method comprising:
an operator coupling the detachable deposition accessory to the autonomous deposition machine;
receiving the at least one deposition instruction from a user;
the autonomous deposition apparatus controlling the detachable deposition accessory to deposit material according to the at least one deposition instruction.

13. A method as claimed in claim 12, wherein after it is coupled to the autonomous deposition machine, the detachable deposition accessory sends data to the autonomous deposition machine.

14. A method as claimed in claim 12, wherein after it is coupled to the autonomous deposition machine, the detachable deposition accessory overrides any deposition arrangement of the autonomous deposition machine.

15. A method as claimed in claim 12, wherein the at least one deposition instruction is a command to print an image in a certain size and the control unit calculates the required sections of the print.

16. A method as claimed in claim 15, wherein the user sends the at least one deposition instruction to the autonomous deposition apparatus via a cloud server or device, or an edge server or device.

17. A method as claimed in claim 12, wherein the material is a herbicide, pesticide, insecticide, plant growth aid, water or marking material, optionally wherein the marking material is a paint, ink, coloured material, powder.
